(19) United States
(12) Patent Application Publication
(10) Pub. No.: US 2017/0015311 A1
(43) Pub. Date: Jan. 19, 2017

(54) A Vehicle Control System

(71) Applicant: Autoliv Development AB, Vårgårda (SE)

(72) Inventors: Alessandro Zin, Saint Ouen l'Aumône (FR); Long Ying, Novi, MI (US)

(21) Appl. No.: 15/124,516

(22) PCT Filed: Mar. 20, 2014
(86) PCT No.: PCT/GB2014/050880

§ 371 Date: Sep. 8, 2016

(51) Int. Cl. B60W 30/045; B60T 8/24; B60W 40/072; B60W 10/18; B60W 40/068; B60T 8/58; B60W 10/06

(52) U.S. Cl. CPC B60W 30/045; B60T 8/58; B60T 8/246; B60W 10/06; B60W 10/18; B60W 40/068; B60W 40/072; B60T 2210/12; B60T 2210/24; B60T 2201/16; B60W 2400/00; B60W 2520/10; B60W 2520/06; B60W 2540/18; B60W 2550/148; B60W 2550/146; B60W 2710/0666; B60W 2710/182

(57) ABSTRACT

A vehicle control system includes: a non-inertial sensor arrangement configured to detect a parameter indicative of a radius of turn for the vehicle that is desired by a driver of the vehicle; a speed detection arrangement operable to detect the forward speed of the vehicle; a friction estimation arrangement, configured to provide an estimated value for the coefficient of friction between at least one tire of the vehicle and a surface over which the vehicle is driven; and a processor connected to receive signals from the non-inertial sensor arrangement, the speed detection arrangement and the friction estimation arrangement.

### CROSS REFERENCE TO RELATED APPLICATIONS

This application claims priority to PCT/GB2014/050880, filed on Mar. 20, 2014.

### FIELD OF THE INVENTION

This invention relates to a vehicle control system, and in particular concerns a system for controlling the speed of a vehicle as the vehicle negotiates a turn.

### BACKGROUND

For any particular vehicle and road conditions, there will be a maximum speed at which the vehicle can safely negotiate a defined turn. Above this maximum speed, it will not be possible for the vehicle to follow the trajectory of the turn and the vehicle may experience understeer, or loss of traction leading to oversteer. In extreme situations the car may even roll over.

It is known for modern vehicles to incorporate a processor which calculates the maximum speed at which a vehicle can follow a given turn, and to reduce the speed of the vehicle if it is determined that the speed of the vehicle exceeds the maximum speed.

It is an object of the present invention to seek to provide an improved system of this type.

### SUMMARY

In one aspect a vehicle control system is provided including a non-inertial sensor arrangement configured to detect a parameter indicative of a radius of turn for the vehicle that is desired by a driver of the vehicle. A speed detection arrangement is operable to detect the forward speed of the vehicle. A friction estimation arrangement is configured to provide an estimated value for the coefficient of friction between at least one tyre of the vehicle and a surface over which the vehicle is driven. A processor is connected to receive signals from the non-inertial sensor arrangement, the speed detection arrangement and the friction estimation arrangement. The processor is configured to determine a desired radius of turn from the signals received from the non-inertial sensor arrangement, and generate a value for the desired turn radius. A maximum safe speed for the vehicle is calculated, based on the desired turn radius and the estimated value for the coefficient of friction, the maximum safe speed representing a forward speed at which the vehicle can safely negotiate a turn having the desired turn radius. A speed reduction signal is generated to instruct speed of the vehicle to be reduced, if the detected forward speed of the vehicle exceeds the maximum safe speed.

Advantageously, the speed reduction signal instructs the speed of the vehicle to be reduced to the calculated safe maximum speed.

Preferably, the speed reduction signal includes a braking signal, instructing the brakes of the vehicle to be applied to reduce the speed of the vehicle.

Conveniently, the speed reduction signal includes an engine control signal, instructing the engine of the vehicle to reduce the engine torque.

Advantageously, the calculation of the maximum safe speed for the vehicle does not take into account a desired turn rate or yaw rate for the vehicle.

Preferably, the maximum safe speed is calculated to be substantially proportional to the square root of the desired turn radius.

Conveniently, the maximum safe speed is calculated using the formula

Vₘₐₓ=\sqrt{μ·g·r_{T}}
where μ is the estimated value for the coefficient of friction, g is the acceleration due to gravity and r_{T} is the desired turn radius.

Advantageously, the non-inertial sensor arrangement is adapted to detect the angle and/or position of the vehicle's steering wheel.

Preferably, the non-inertial sensor arrangement is adapted to detect the direction in which the eyes of the driver of the vehicle are pointing.

Conveniently, the non-inertial sensor arrangement includes a positioning system.

Advantageously, the friction estimation arrangement includes a memory having one or more stored values of coefficient of friction, and the coefficient of friction between at least one tire of the vehicle and a surface over which the vehicle is driven is estimated by retrieving a stored value from the memory.

Preferably, the friction estimation arrangement includes one or more sensors, and the coefficient of friction between at least one tire of the vehicle and a surface over which the vehicle is driven is estimated based on signals from the one or more sensors.

Another aspect provides a vehicle including a vehicle control system according of the foregoing embodiments.

Conveniently, the brakes or engine of the vehicle are configured to be controlled by the vehicle control system.

### BRIEF DESCRIPTION OF THE DRAWINGS

In order that the invention may be more readily understood, embodiments thereof will now be described, by way of example, with reference to the accompanying drawings, in which:

FIG. 1 shows a graph of target yaw rate versus vehicle speed, for a variety of steering wheel angles;

FIG. 2 shows a graph of possible yaw rates versus vehicle speed, for a variety of coefficients of friction between the vehicle's tires and the road surface;

FIG. 3 shows a graph of required yaw rates to negotiate turns having different radii;

FIG. 4 shows a graph representing a vehicle turning under stable conditions;

FIG. 5 shows a graph representing a vehicle turning under conditions where the vehicle speed is excessively high; and

FIG. 6 is a schematic view of a vehicle incorporating a control system embodying the present invention.

### DETAILED DESCRIPTION

In conventional systems, a vehicle processor calculates a target yaw rate for the vehicle, as the vehicle negotiates a turn. As will be understood by those skilled in the art, the yaw rate of a vehicle is the angular speed at which the vehicle turns around a vertical axis passing through the vehicle (i.e. the yaw axis).

It is known in conventional systems to calculate the target yaw rate for a vehicle using the following formula:

$${ω}_{Target} = \frac{SWA \text{/} G}{L} . ( \frac{V}{1 + \frac{{V}^{2}}{{V}_{C}^{2}}} )$$

In this formula, SWA is the steering wheel angle, i.e. the angle through which the steering wheel has been turned away from its default, “straight ahead” position. G is the steering wheel to road wheel angle ratio, i.e. the ratio of the angle through which the steering wheels of the vehicle turn to the angle through which the steering wheel itself is turned.

L represents the vehicle wheel base length, and V is the current vehicle speed. V_{c} is the “characteristic speed” of the vehicle, and is a fixed, known vehicle parameter.

It will be understood that, in the above formula, SWA and V are variables, with the remaining parameters being fixed. A target yaw rate is therefore determined based on the vehicle speed and the angle at which the steering wheel is set by the driver.

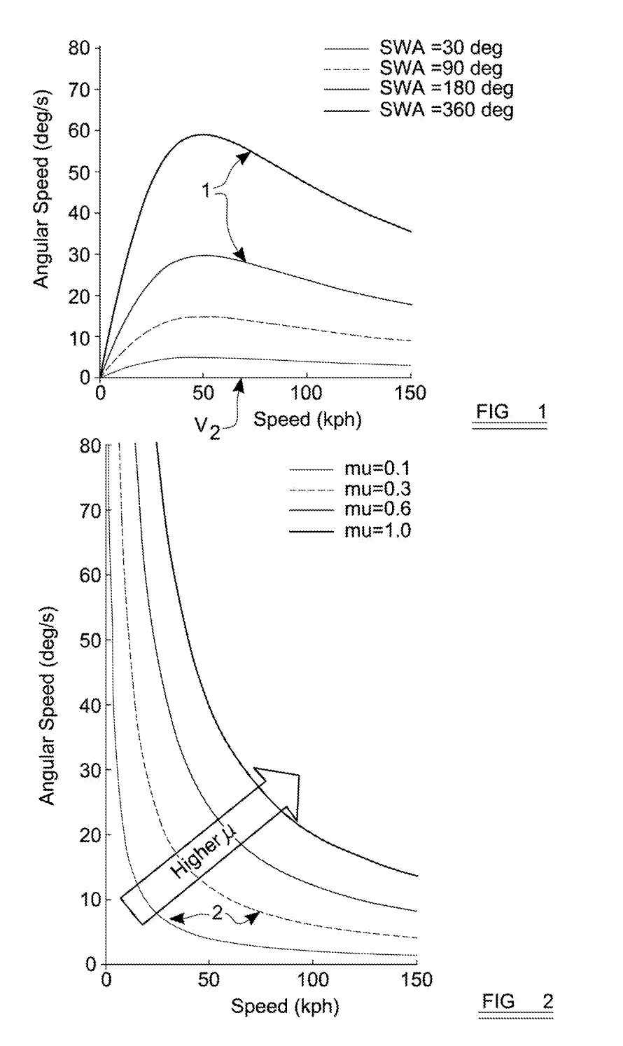

Referring to FIG. 1, a graph is shown of target yaw rate (on the Y-axis of the graph) calculated using this formula, versus vehicle speed (on the X-axis). Four different lines 1 are shown for different steering wheel angles.

All of the target yaw rates are at their maximum for a speed of 55 km/h, with this speed corresponding to the vehicle's characteristic speed (V_{c}).

At speeds lower than this, the traction of the vehicle on the road surface will be good, but the nose of the vehicle will turn at a relatively low rate because the speed of the vehicle is low.

At the speeds above the characteristic speed, the vehicle cannot turn rapidly due to a lack of grip between the road surface and the vehicle's tires.

It has been found that, when a vehicle processor calculates a target yaw rate as outlined above, and reduces the vehicle speed if it is above this yaw rate, the reduction in speed is felt to be excessive by many drivers. Drivers may therefore find that the automatic reduction in speed imposed by the vehicle's processor is overly conservative and interfering, and may switch off this aspect of the vehicle's control.

In embodiments of the invention, an alternative approach is used, in which a maximum vehicle speed is calculated based on an estimated target vehicle turn radius. This will be explained in more detail below.

Turning to FIG. 2, a graph is shown of the yaw rate which, at a particular speed, is possible in view of the coefficient of friction between the road surface and the vehicle's tires.

In general, the maximum yaw rate is defined by the following formula:

$${ω}_{max} = \frac{μ . g}{V {.}^{180} \text{/} π}$$

In this formula μ represents the coefficient of friction, and g represents the acceleration due to gravity. Four curves 2 are shown on the graph for four different values of μ and, (as will be expected) higher turn rates are possible when μ is higher.

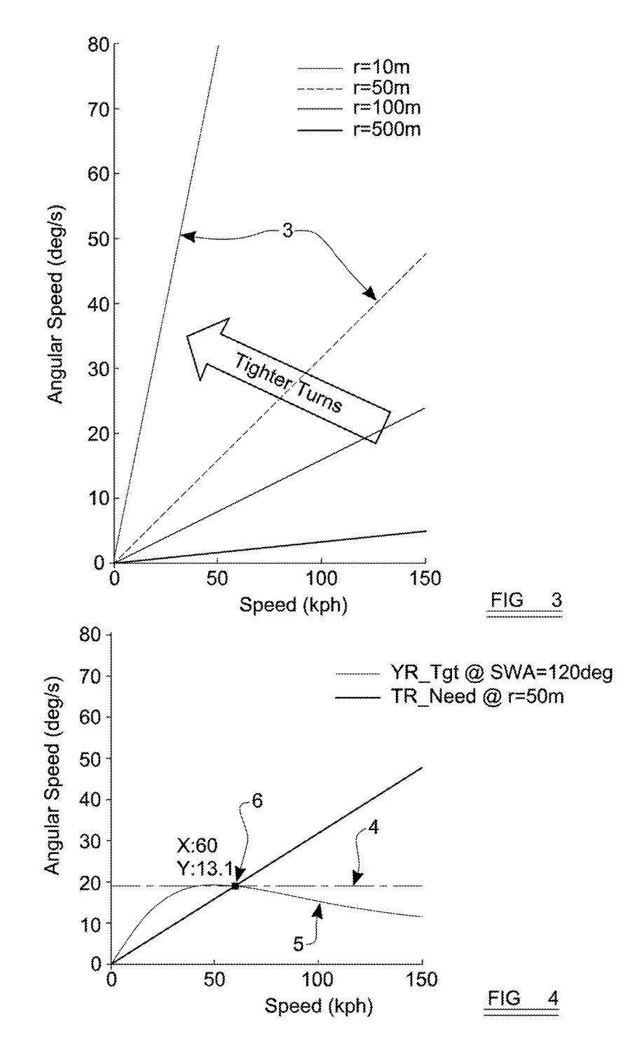

FIG. 3 shows the yaw rate required to negotiate a corner having a radius of r, with four separate lines 3 representing four values of r. This required yaw rate is defined by the formula:

$${ω}_{Req} = \frac{V}{r {.}^{180} \text{/} π}$$

As will be expected, for tighter turns (i.e. turns with a smaller radius) a higher yaw rate is required.

Turning to FIG. 4, a graph is shown representing a situation in which a vehicle turns under stable conditions. The speed of the vehicle is 60 km/h, and the steering wheel is set at 120° from the default “straight ahead” position.

Using the formula set out above, the target yaw rate 4 for the vehicle is calculated to be 19.1°/s. A curve 5 representing the target yaw rate for the selected steering wheel angle (similar to the curve 5 shown in the graph of FIG. 1) also appears in FIG. 4, and on the graph this curve intersects both the target yaw rate 4 and the speed of the vehicle at the same point 6.

Also shown in FIG. 4 is a line 7 representing the required turn rate (similar to the line shown on the graph of FIG. 3) for a turn radius of 50 metres, which is the radius of the turn negotiated by the vehicle in this example. This line 7 also intersects, at the same point 6 on the graph, the target yaw rate 4 and vehicle speed.

As stated above this graph represents a stable condition, in which the driver sets the angle of the steering wheel and negotiates the turn at a speed which does not lead to any immediate risk. In the situation represented in this graph, the vehicle processor would not take action to reduce the speed of the vehicle.

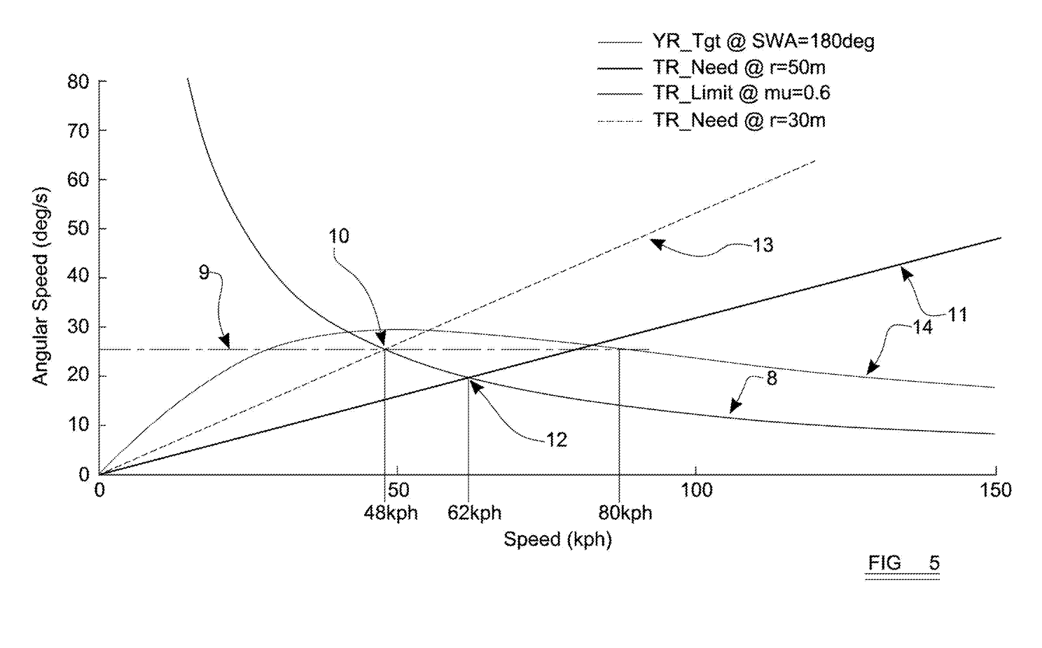

Turning to FIG. 5, a further graph is shown representing a situation in which a vehicle is travelling at an initial speed of 80 km/h, and the driver sets the steering wheel at 180° to the default “straight ahead” position. A curve 14 represents the target yaw rate for this steering wheel angle.

Firstly, under a conventional system as described above, the vehicle processor determines that the driver has set a target yaw rate 9 of 26.1°/s (as calculated using the equation above).

The graph of FIG. 5 includes a curve 8, as shown in FIG. 2, showing the maximum yaw rate which is supported by the coefficient of friction between the tires of the vehicle and the road surface. It can be seen that the point 10 at which the calculated target yaw rate 9 intersects this curve 8 corresponds to a speed of 48 km/h. A system working on this conventional analysis would therefore reduce the speed of the vehicle to 48 km/h. As an aside, at this speed, with the steering wheel angle remaining at 180°, the vehicle will describe a turn having a radius of 30 meters, indicated on the graph by a line 13.

In at least one embodiment, however, it may be determined that the driver has set a target turn radius of 50 meters. A line 11 representing the turn rate required to negotiate a turn having this radius is shown in FIG. 5, and this line 11 is similar to those shown in the graph of FIG. 3. It can be seen that, where this line 11 intersects the curve 8 showing the turn rate that can be supported by the coefficient of friction between the vehicle's tires and the road surface, this intersection occurs at a point 12, corresponding to a speed of 62 km/h. A system according to this embodiment would therefore aim to reduce the speed of a vehicle to 62 km/h to negotiate this turn. As an aside, when negotiating this turn at 62 km/h, the vehicle would turn at a yaw rate of 19.56°/s.

It can therefore be seen that for this given set of circumstances, analyzing the situation based on a target turn radius leads to a higher determined maximum safe speed (and hence to a lesser reduction in the vehicle's speed) than a conventional analysis which is based on the target yaw rate. The driver of the vehicle will therefore be likely to find that a system embodying the invention involves less interference, and the driver is less likely to deactivate this aspect of the vehicle's control.

In addition, it will be understood that, if the vehicle's speed is reduced by a greater amount than necessary, more of the vehicle's forward momentum will be lost and the vehicle is likely to consume a larger amount of fuel.

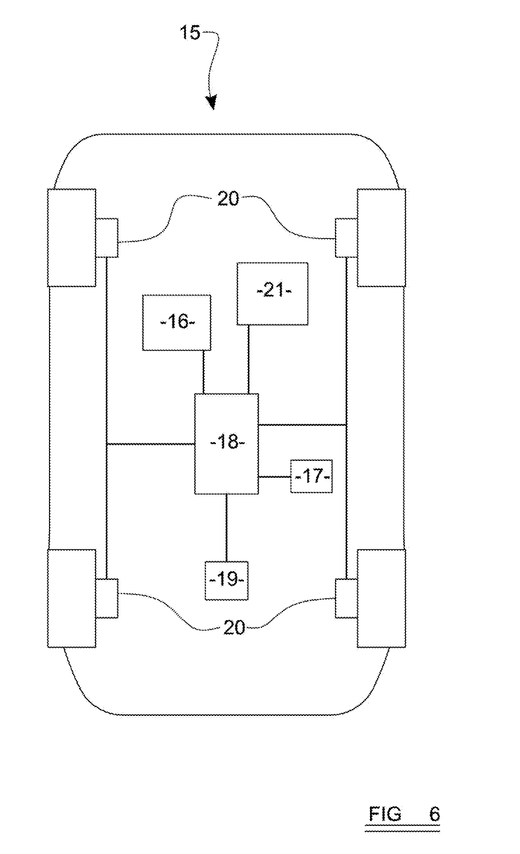

FIG. 6 shows a schematic view of a vehicle 15 having a control system embodying the present invention.

The vehicle includes a non-inertial sensor arrangement 16 which is configured to detect a parameter which is indicative of a desired radius of turn of the vehicle. In the embodiments described above, this sensor arrangement 16 detects the angle at which the vehicle's steering wheel is set. Alternatively, or in addition, a vision system may be used, which (as will be understood by the skilled reader) determines the direction in which the driver's eyes are pointing. Further, alternatively or in addition, a positioning system such as a GPS system may be used.

The vehicle also involves a speed detection arrangement 17 which, through information gathered or measurements made from one or more vehicle sensors, is operable to detect the forward speed of the vehicle. Preferably a positioning system such as a GPS system is used for this purpose, although information from wheel rotation sensors may also be used.

The vehicle includes a processor 18, which is connected to the various components of the control system. It will be understood that this processor 18 may include only one processing unit, or may comprise a plurality of distributed processing units, as is known in the art.

The processor is operable to provide an estimation of the coefficient of friction between at least one tire of the vehicle and the surface over which the vehicle is driven. In some embodiments, this may include a memory 19 in which values of coefficient μ friction are stored, and are retrieved for calculating purposes. The memory may store, for instance, values corresponding to dry road conditions, wet road conditions, icy road conditions, snow road conditions, off-road conditions and also values corresponding to new or worn tires. Various vehicle sensors and/or vehicle data inputs from external sources (such as weather data sources) may allow the processor 18 to determine which value of coefficient of friction is the most appropriate to use at any time.

Alternatively, the processor 18 may calculate, directly from information received from various vehicle sensors, the coefficient of friction between the vehicle's tires and the road surface. Information may be gathered, for example, from one or more onboard cameras, wheel rotation sensors, a positioning system and so on, as will be understood by those skilled in the art.

Based on the apparent desired radius of turn r_{T} for the vehicle 15, the vehicle's speed and the estimation of the coefficient of friction, the processor 18 is operable to determine the maximum safe speed for the vehicle 15. In preferred embodiments, this safe speed is calculated using the formula Vₘₐₓ=\sqrt{μ·g·r_{T}}. If the speed of the vehicle 15 is above this maximum safe speed, the processor generates 18 a speed reduction signal to reduce the vehicle speed to the determined safe maximum.

In some embodiments the speed reduction signal may include a braking signal, instructing the brakes 20 of the vehicle 15 to be applied to reduce the vehicle's speed.

In alternative embodiments, the speed reduction signal may be an engine control signal, which instructs the engine 21 to reduce engine torque, thus reducing the vehicle's speed.

In further embodiments, the speed reduction signal may instruct the brakes of the vehicle to be applied and also for engine torque to be reduced. In some embodiments, if the detected vehicle speed is above the determined safe maximum speed by a certain margin (for example, 20 km/h or 30 km/h), the speed reduction signal may activate the vehicle's brakes and reduce the engine torque, as the speed of the vehicle needs to be reduced rapidly. In situations where the detected vehicle speed is above the determined safe maximum speed by less than the margin, the speed reduction signal may activate the brakes of the vehicle or reduce the engine torque, but not both. In further embodiments, the speed reduction signal may instruct the brakes of the vehicle to be applied and also for engine torque to be reduced regardless of the difference between the detected vehicle speed and the determined safe maximum speed.

It will be appreciated that embodiments of the invention provide a vehicle control system which can help to maintain the safety of the vehicle and its occupants, while not interfering in the driver's control of the vehicle any more than is necessary.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

While the above description constitutes the preferred embodiment of the present invention, it will be appreciated that the invention is susceptible to modification, variation and change without departing from the proper scope of the fair meaning of the accompanying claims.

1. A vehicle control system comprising:
a non-inertial sensor arrangement configured to detect a parameter indicative of a radius of turn for a vehicle that is desired by a driver of the vehicle;
a speed detection arrangement operable to detect a forward speed of the vehicle;
a friction estimation arrangement configured to provide an estimated value for a coefficient of friction between at least one tire of the vehicle and a surface over which the vehicle is driven; and
a processor connected to receive signals from the non-inertial sensor arrangement, the speed detection arrangement and the friction estimation arrangement, wherein the processor is configured to:
determine a desired radius of turn from the signals received from the non-inertial sensor arrangement, and generate a value for the desired radius of turn;
calculate a maximum safe speed for the vehicle, based on the desired radius of turn and the estimated value for the coefficient of friction, the maximum safe speed representing a forward speed at which the vehicle can safely negotiate a turn having the desired turn radius of turn; and
generate a speed reduction signal to instruct speed of the vehicle to be reduced if a detected forward speed of the vehicle exceeds the maximum safe speed.

2. A vehicle control system according to claim 1, wherein the speed reduction signal instructs the speed of the vehicle to be reduced to the safe maximum speed.

3. A vehicle control system according to claim 1, wherein the speed reduction signal comprises a braking signal instructing the brakes of the vehicle to be applied to reduce the speed of the vehicle.

4. A vehicle control system according to claim 1, wherein the speed reduction signal comprises an engine control signal instructing the engine of the vehicle to reduce an engine torque.

5. A vehicle control system according to claim 1, wherein calculation of the maximum safe speed for the vehicle does not take into account a desired turn rate or yaw rate for the vehicle.

6. A vehicle control system according to claim 1, wherein the maximum safe speed is calculated to be substantially proportional to a square root of the desired radius of turn.

7. A vehicle control system according to claim 1, wherein the maximum safe speed is calculated using a formula
Vₘₐₓ=\sqrt{μ·g·r_{T}}
where μ is an estimated value for the coefficient of friction, g is an acceleration due to gravity and r_{T} is the desired radius of turn.

8. A vehicle control system according to claim 1, wherein the non-inertial sensor arrangement is adapted to detect an angle and/or position of a vehicle's steering wheel of the vehicle.

9. A vehicle control system according to claim 1, wherein the non-inertial sensor arrangement is adapted to detect a direction in which eyes of the driver of the vehicle are pointing.

10. A vehicle control system according to claim 1, wherein the non-inertial sensor arrangement comprises a positioning system.

11. A vehicle control system according to claim 1, wherein the friction estimation arrangement comprises a memory having one or more stored values of coefficient of friction, and the coefficient of friction between at least one tire of the vehicle and the surface over which the vehicle is driven is estimated by retrieving one of the stored values from the memory.

12. A vehicle control system according to claim 1, wherein the friction estimation arrangement comprises one or more sensors, and the coefficient of friction between at least one tire of the vehicle and the surface over which the vehicle is driven is estimated based on signals from the one or more sensors.

13. A vehicle including a vehicle control system according to claim 1.

14. A vehicle according to claim 13, wherein brakes or an engine of the vehicle are configured to be controlled by the vehicle control system.
